(19) United States
(12) Patent Application Publication
(10) Pub. No.: US 2024/0317589 A1
(43) Pub. Date: Sep. 26, 2024

(54) CARBONACEOUS MATERIALS FOR USE IN METHODS OF MANUFACTURING ACTIVATED CARBON

(71) Applicant: ARQ IP LIMITED, London (GB)

(72) Inventors: Stephen Carl PASPEK, Broadview Heights, OH (US); John Francis UNSWORTH, London (GB); Jeramie Joseph ADAMS, London (GB); Seth Taylor BASSHAM, London (GB); Regina RODRIGUEZ, London (GB); David MAZYCK, London (GB)

(21) Appl. No.: 18/574,432

(22) PCT Filed: Jun. 29, 2022
(86) PCT No.: PCT/US2022/035480

§ 371 Date: Dec. 27, 2023

Related U.S. Application Data
(60) Provisional application No. 63/216,641, filed on Jun. 30, 2021.

(51) Int. Cl. C01B 32/318; C02F 1/28

(52) U.S. Cl. CPC C01B 32/318; C02F 1/283; C01P 2004/60; C01P 2006/12; C01P 2006/82

(57) ABSTRACT

Activated carbon (AC) produced from agglomerated purified carbonaceous product (PCP) are provided. The PCP is in particulate form, at least about 90% by volume (% v) of the particles are no greater than about 25 _{J.1}m in diameter; the PCP has an ash content of less than about 5% m and a water content of up to about 60% m. The PCP may be used to make AC, or utilized as an additive for production of AC from other carbonaceous feedstocks.

### FIELD

The invention relates to methods for the manufacture of activated carbon materials, particularly from coal feedstocks.

### BACKGROUND

Activated carbon (AC) is a large market for coal-based materials with about 1.4 million tons sold in 2018. Feedstocks for AC can be from agricultural materials such as coconut shells, biomass, sawdust, and coal. Coals are different from other feedstocks because they already contain inherent micro porosity and do not need to be initially carbonized to create micro porosity. In general, non-fusible lower rank coals (lignite and subbituminous) have more porosity and surface area than higher rank coals and are used to produce AC. AC from coal is generally produced from low fluidity coals which do not undergo melting, or plastic phase transitions, because this closes off the porous structure. AC can be produced from these materials if the structure is stabilized by oxidation prior to the removal of volatiles and further activation.

Coal fines and ultrafines, including microfines, are the small particles of coal generated from larger lumps of coal during the mining and preparation process. While coal fines retain the same energy potential of coal they are generally considered a waste product as the particulate nature of the product renders it difficult to market and transport. As much as 70-90 million tonnes of coal fines are produced in the US alone as waste by-product every year by the mining industry (Baruva, P., Losses in the coal supply chain, IEA Clean Coal Centre Rep.CCC/212, p. 26, December 2012, ISBN 978-92-9029-532-7), the vast majority of which is left unused. Coal fines are therefore generally discarded as spoil close to the colliery forming large waste heaps or contained in large ponds that require careful future management in order to avoid environmental contamination.

Coal seams with high ash content are abundant worldwide, from numerous geological reserves, sometimes as thick seams persisting over a wide geographical area, but many are not exploitable economically for use in AC production due to high ash content (>20% m dry basis) which reduces adsorption efficiency.

Clean coal technologies have provided for development of new classes of specialty fuels that comprise upgraded clean coal blends as described in International Patent Application No. WO2020/065341 or hybrid liquid-solid mixtures as described in U.S. Pat. No. 9,777,235, with higher energy density and lower levels of emissions. There is a further need to identify additional uses for clean coal compositions derived from waste and low-grade solid hydrocarbons that can contribute to the improvement of the expanding global green economy. Hence, it would be desirable to provide alternative and economical sources of high-quality feedstocks for non-fuel technologies which in turn bring about longer term, more sustainable, and greener future for communities that are dependent upon the coal industry for their economic wellbeing.

Conventional manufacture of AC from coal is summarized briefly in the prior art process depicted in FIG. 1. Coal feedstock is pulverized and crushed down typically to pass a 10-mesh U.S. standard size (i.e. particle diameter less than 2 mm) before oxidation and devolatilization steps. Screening and dust removal stages ensure that particle sizes <75 microns (e.g. microfines) are removed as these size ranges are usually considered too small to handle during activation. The particulate coal is activated by either chemical or physical means. In FIG. 1 activation is achieved via use of steam at elevated temperature. The AC product is further classified and may be subjected to further milling steps if finer particulate AC is required for a given purpose. For example, in U.S. Pat. No. 10,029,235 B1 a preparation of AC is subjected to jet milling and other finer milling steps to reduce the AC particle size to <28 microns in order to be suitable for use as a sorbent in mercury removal from flue gas. Hence the conventional approach to production of more finely divided AC is to activate larger particle size compositions prior to milling down to finer grades.

It would be desirable to provide improved feedstocks for use in the production of AC. It would also be desirable to provide improved feedstocks that comprise a greater diversity of origins, but which meet the standards for high specification AC products that are used in production of pharmaceuticals, chemical synthetic processes, and other highly specialized industries. In addition, it would be desirable to utilize feedstocks that are derived from materials otherwise classified as discard or previously thought unsuitable, thereby allowing for upcycling of industrial waste and reducing the further accumulation of waste fines as a by-product of coal mining activities.

### SUMMARY OF THE INVENTION

The invention relates to improvements in processes for the production of high surface area AC from microfine coal feedstocks.

The present inventors have developed a process that provides for the utilisation of very high quality (low ash, sulfur, and water content) purified carbonaceous products hitherto considered to be unsuitable for AC production. These purified carbonaceous products have typically been upgraded from waste from coal tailings ponds, impoundments or tips and reject materials from current coal production processing (e.g. thickener underflow or tailings underflow waste streams), as well as high-ash content inferior seam coal, hitherto not exploitable economically.

According to a first aspect of the present invention, there is provided a process for the production of an activated carbon (AC), the process comprising the steps of:
(i) providing an agglomerated purified carbonaceous product (PCP), wherein the PCP is in particulate form, and wherein at least about 90% by volume (% v) of the particles are no greater than about 25 μm in diameter; wherein the PCP has an ash content of less than about 5% m; and a water content of up to 60% m
(ii) subjecting the agglomerated PCP to at least one thermal treatment thereby forming thermally treated agglomerated PCP; and
(iii) subjecting the thermally treated agglomerated PCP to at least one activation process in order to produce an AC.

A second aspect of the invention provides an activated carbon composition prepared according to the processes described herein, wherein the composition has a BET surface area of at least 500 m²/g.

In a third aspect, the invention provides an activated carbon composition prepared according to the processes described herein, wherein the composition has a BET surface area of at least 1000 m²/g.

A fourth aspect of the invention provides a process for the production of an AC product, the process comprising the steps of:
(i) providing a carbonaceous feedstock material in particulate form;
(ii) agglomerating the carbonaceous feedstock material with a binder, thereby forming an agglomerated feedstock, wherein the binder comprises a purified carbonaceous product (PCP), wherein the PCP is in particulate form, at least about 90% by volume (% v) of the particles are no greater than about 25 μm in diameter; wherein the PCP has an ash content of less than about 5% m;
(iii) subjecting the agglomerated feedstock to at least one thermal treatment thereby forming thermally treated agglomerated feedstock; and
(iv) subjecting the thermally treated agglomerated feedstock to at least one activation process in order to produce an AC composition.

A fifth aspect of the invention provides, an activated carbon composition prepared according to the processes described herein, wherein the composition has a BET surface area of at least 500 m²/g and an ash content of less than 5% m of ash.

A sixth aspect of the invention provides a process for the adsorption of a substance comprised within a fluid stream, the process comprising exposing the fluid stream to an activated carbon product prepared according to the processes described herein.

A seventh aspect of the invention provides the use of an agglomerated purified carbonaceous product (PCP) as an additive feedstock to increase the BET surface area of a biochar derived activated carbon product, wherein the PCP is in particulate form, at least about 90% by volume (% v) of the particles are no greater than about 25 μm in diameter; wherein the PCP has an ash content of less than about 5% m and a water content of up to about 60% m.

It will be appreciated that the invention may be subjected to further combinations of the features disclosed herein but which are not explicitly recited above.

### DRAWINGS

The invention is further illustrated by reference to the accompanying drawings in which:

FIG. 1 is a process flow diagram showing a prior art method for the production of an activated carbon material from a bituminous coal feedstock.

FIG. 2 is a graph that illustrates how the BET Surface Area increases with increasing activation time for activated carbons prepared from four types of PCP samples according to embodiments of the invention.

FIG. 3 is a graph showing yields of activated carbon prepared from various types of PCP samples according to embodiments of the invention for different activation times.

FIG. 4 is a graph showing the removal efficiency of the contaminant substance, 2-methylisoborneol (MIB), from drinking water compared for a PCP-derived activated carbon and a commercially available reference activated carbon.

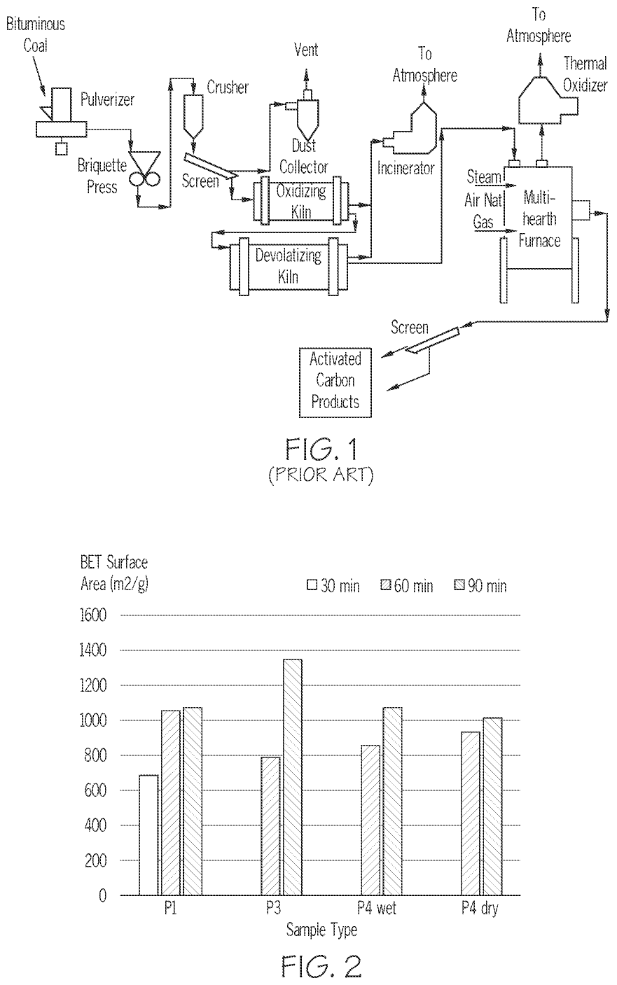

### DETAILED DESCRIPTION OF THE INVENTION

All references cited herein are incorporated by reference in their entirety. Unless otherwise defined, all technical and scientific terms used herein have the same meaning as commonly understood by one of ordinary skill in the art to which this invention belongs.

Prior to setting forth the invention in greater detail, a number of definitions are provided that will assist in the understanding of the invention.

As used herein, the term “comprising” means any of the recited elements are necessarily included and other elements may optionally be included as well. “Consisting essentially of” means any recited elements are necessarily included, elements that would materially affect the basic and novel characteristics of the listed elements are excluded, and other elements may optionally be included. “Consisting of” means that all elements other than those listed are excluded. Embodiments defined by each of these terms are within the scope of this invention.

As used herein, the term “about” when used in combination with an absolute value refers to a tolerance of 1% of that value above or below the absolute value being described.

The term “coal” is used herein to denote readily combustible sedimentary mineral-derived solid hydrocarbonaceous material including, but not limited to, hard coal, such as anthracite; bituminous coal; sub-bituminous coal; and brown coal including lignite (as defined in ISO 11760:2005). “Native” or “feedstock” coal refers coal that has not been subjected to extensive processing and comprises a physical composition (e.g. maceral content) that is substantially unchanged from the point of extraction. In contrast, the terms “coal-derived product”, “coal replacement product” and “purified coal compositions” are used herein to refer to various coals which have been subjected to one or more processes that lead to a change in physical and/or chemical compositions of the coal such that it is substantially changed from the point of extraction—i.e the natural state.

The term “hydrocarbonaceous material” as used herein refers to a material containing hydrocarbons; hydrocarbons being an organic compound consisting substantially of the elements, hydrogen and carbon. Hydrocarbonaceous material may comprise aliphatic as well as aromatic hydrocarbons. Carbonaceous materials tend to comprise majority carbon with a lower hydrogen content—e.g <5% m hydrogen, typically less than 2% m hydrogen. Carbonaceous materials as well as hydrocarbonaceous materials may be used as feedstocks for the production of activated carbon. For example, bituminous coal represents an exemplary native feedstock that is hydrocarbonaceous in origin, whereas biochar or charcoal, both derived from the pyrolysis of biomass, are representative of predominantly, but not exclusively, carbonaceous feedstock materials. It will be understood, therefore, that hydrocarbonaceous materials are a sub-class of carbonaceous materials, in that in addition to their carbon content they also contain hydrogen.

The term “purified carbonaceous product” or “PCP” as used herein refers to a material that is comprised of a carbonaceous substance of geological or biological origin—e.g. coal, coke, pet coke, and/or biochar. A PCP is typically subjected to various process steps to reduce non-carbonaceous substances that are present, such as ash or sulfur, to a minimum. As mentioned above, purified coal compositions are different to coals in their native or un-purified state. Likewise, carbonaceous substances may be purified from starting feedstocks of coke, pet coke, or biochar that are subjected to processes to deplete non-carbonaceous content, such as ash, sulfur, and/or water. Typically, the PCP of geological or biological origin according to embodiments of the present invention will comprise an ash content of less than 5% m, suitably less than 4% m, optionally less than 3% m, in certain cases less than 2% m, and in specific embodiments no more than 1% m.

As used herein, the term “ash” refers to the inorganic—e.g. non-hydrocarbon—mineral component found within most types of fossil fuel, especially that found in coal. Ash is comprised within the solid residue that remains following combustion of coal, sometimes referred to as fly ash. As the source and type of coal is highly variable, so is the composition and chemistry of the ash. However, typical ash content includes several oxides, such as silicon dioxide, calcium oxide, iron (III) oxide and aluminium oxide. Depending on its source, coal may further include in trace amounts one or more substances that may be comprised within the subsequent ash, such as arsenic, beryllium, boron, cadmium, chromium, cobalt, lead, manganese, mercury, molybdenum, selenium, strontium, thallium, and vanadium.

As used herein the term “low ash coal” refer to native coal that has a proportion of ash-forming components that is lower when compared to other industry standard coals. Typically, a low ash native or feedstock coal will comprise less than around 12% m ash. The term “deashed coal”, or the related term “demineralised coal”, is used herein to refer to coal that has a reduced proportion of inorganic minerals compared to its natural native state. Ash content may be determined by proximate analysis of a coal composition as described in ASTM D3174—12 Standard Test Method for Ash in the Analysis Sample of Coal and Coke from Coal. In embodiments of the present invention ash content in purified carbonaceous product derived predominantly from coal is less than 5% m, less than 3% m, less than 2% m and less than 1.5% m or even less than 1% m are obtained. Indeed, the present inventors have found quite unexpectedly that products having very low ash contents of around or below 1% m can be obtained from starting material that is as much as 50% m ash without having to sacrifice yield levels that render the process un-commercial.

Inferior coal is a term used in geological survey of the quality of coal seams (e.g. UK coal survey, 1937) and refers to intrinsic ash in coal bands or coal seams above 15.1% m and below 40.0% m. Coal bands or coal seams consisting of inferior coal contain mineral matter intimately mixed within the coal itself and consequently are very difficult to purify using conventional coal processing techniques.

As used herein, the term “coal fines” refers to coal in particulate form with a maximum particle size typically less than 1.0 mm. The term “coal ultrafines” or “ultrafine coal” or “ultrafines” refers to coal with a maximum particle size typically less than 0.5 mm (500 microns (μm), approximately 0.02 inches). The term “coal microfines” or “microfine coal” or “microfines” refers to coal with a maximum particle size typically less than 20 μm.

Most suitably the maximum average particle size of the of PCP, whether derived from coal or other sources, may be at most 75 μm, 50 μm, 40 μm, 30 μm, 20 μm, 25 μm, 20 μm, 15 μm, 10 μm, or 5 μm. The minimum average particle size may be 0.01 μm, 0.1 μm, 0.5 μm, 1 μm, 2 μm, or 5 μm.

An alternative measure of particle size is to quote a maximum particle size and a percentage value or “d” value for the proportion by volume of particles within the sample that fall below that particle size. Suitably, the particle size of the PCP material is in the ultrafine range. Most suitably the particle size of the PCP is in the microfine range. Specifically, the maximum particle size may be at most 500 μm. More suitably, the maximum particle size may be at most 300 μm, 250 μm, 200 μm, 150 μm, or 100 μm. Most typically, however, the maximum particle size may be at most 75 μm, 50 μm, 40 μm, 30 μm, 20 μm, 10 μm, or 5 μm. The minimum particle size may be 0.01 μm, 0.1 μm, 0.5 μm, 1 μm, 2 μm, or 5 μm. Any “d” value may be associated with any one of these particle sizes. Suitably, the “d” value associated with any of the above maximum particle sizes may be d99, d98, d95, d90, d80, d70, d60, or d50. For instance, in a specific embodiment of the invention the PCP has a d90 of <70 μm, <50 μm, optionally <20 μm, and suitably <10 μm. Suitably, the PCP has a d95 of <25 μm, <20 μm, <15 μm, <12 μm, and optionally <10 μm.

As used herein, the term “water content” refers to the total amount of water within a sample and is expressed as a concentration or as a mass percentage (% m). When the term refers to the water content in a PCP sample it includes the inherent or residual water content of the material, and any water or moisture that has been absorbed from the environment, for example as a result of the PCP purification process. As used herein the term “dewatered coal” refers to coal that has an absolute proportion of water that is lower than that of its natural state. The term “dewatered coal” may also be used to refer to coal that has a low, naturally occurring proportion of water. Water content may be determined by analysis of a native or purified coal composition as described in ASTM D3302/D3302M—17 Standard Test Method for Total Moisture in Coal.

As used herein, the term “thermal treatment” refers to thermal pre-treatments that may be carried out below usual pyrolysis temperatures of 600° C., suitably below 550° C., typically below 500° C., and optionally around 450° C., without impairing the capacity to generate high surface area materials during subsequent activation. Thermal treatment leads to devolatilization of the PCP at which point the resultant material may be subjected to chemical or physical activation in order to produce an AC composition.

As used herein, the term “activation” and its derivatives refer to a process in which a hydrocarbonaceous or carbonaceous material, such as PCP, is rendered more porous as a result of a physical or chemical treatment, or both. Hence, as used herein, the terms “activated carbon” (AC) or “activated carbon particles” and their derivatives are intended to refer to carbon particles that have been subjected to an activation process that results in an increase in porosity resulting in a corresponding increase in the effective surface area (SA) of the particles.

AC is a form of carbon, which is highly porous over a broad range of pore sizes, from visible cracks and crevices to cracks and crevices of molecular dimensions resulting in very high internal surface area making it ideal for adsorption uses. AC is one of the largest markets for carbon materials produced from coal, coke and biochar. It is used in various applications for the purification of water, food, chemicals, pharmaceuticals, blood, and gases. Each application requires an AC with different surface area properties, pore morphology, purity level and surface functionalization. At the most basic level, AC application and value is largely dictated by the surface area that can be achieved from a particular carbon source. AC is suitably defined by ASTM D2652-11 (Reapproved 2020) Standard Terminology Relating to Activated Carbon as “a family of carbonaceous substances manufactured by processes that develop adsorptive properties”. Activation Is suitably defined by ASTM D2652-11 (Reapproved 2020) as “any process whereby a substance is treated to develop adsorptive properties.”

As used herein, the term “activated carbon product” is used to define an activated carbon produced from more than one feedstock of carbonaceous material. For example, an activated carbon product made be produced from a carbonaceous feedstock that includes native coal, biochar or charcoal, that is combined with a PCP, in particular a PCP binder.

Powdered activated carbon (PAC) suitably is defined by ASTM D2652-11 (Reapproved 2020) Standard Terminology Relating to Activated Carbon as “activated carbon with a mean particle diameter less than 45 μm.” PAC is typically made from larger particles of activated carbon that are then crushed, milled or ground down to a smaller size range. The adsorption kinetics of activated carbon increases as the particle size decreases. PAC is often used for water and gas treatment.

Granular activated carbon (GAC) suitably is defined by ASTM D2652-11 (Reapproved 2020) Standard Terminology Relating to Activated Carbon as “activated carbon in particle sizes predominantly greater than 80 mesh” (175 microns). GAC, thus, has a relatively larger particle size compared to powdered activated carbon and consequently, presents a smaller external surface for adsorption. GAC is suitable for adsorption of gases and vapors because they diffuse rapidly. GAC is used for water treatment, deodorization and separation of components of flow systems.

Demineralising and dewatering of carbonaceous materials, such as coal fines, to produce a PCP that can be used as a direct feedstock for the production of AC compositions or as a binder in combination with other feedstocks may be achieved via a combination of froth flotation separation, specifically designed for ultrafines and microfine particles, plus mechanical and thermal dewatering techniques. Typically, PCP may be produced from a feedstock of particulate coal via processes that comprise particle size reduction, mineral matter removal, dewatering and, optionally, drying. Some or all of these steps may be altered or modified to suit the specification of the starting material or of the desired end product. The key process steps are summarised below in relation to a typical starting coal material derived from an impoundment, tailings pond or production tailings underflow.

### Particle Size Reduction

The starting material is reduced to a particle size of d80=30−50 microns (or finer in some coals) to achieve efficient separation to a target mineral matter (ash) content of 5-8% m. To achieve this, a feed comprising the starting material is diluted with water to achieve a solids content of in the range 20-40% m, then ground in a ball mill or bead mill depending on the top size of the feedstock. The product is screened at a size range of approximately 100 microns to exclude particles above this size. A dispersant additive may be included to optimise energy use during size reduction (e.g. lignin-based dispersants, such as Borresperse, Ultrazine and Vanisperse manufactured by Borregaard, 1701 Sarpsborg, Norway). Suitable equipment for size reduction is manufactured by Metso Corporation, Fabianinkatu 9 A, PO Box 1220, FI-00130 Helsinki, FIN-00101, Finland; Glencore Technology Pty. Ltd., Level 10, 160 Ann St, Brisbane QLD 4000, Australia, and FLSmidth, Vigerslev Allé 77, 2500 Valby, Denmark.

### Ash Removal

One or a series of froth flotation stages are carried out to bring the entrained mineral content down to the target level. For some coals where the mineral matter is disseminated mainly within sub-10-micron size domains, more than one stage of flotation following further milling may be required to achieve a low ash level.

During froth flotation a coal slurry is diluted further with water typically to a range of 5-20% m solids then collected in a tank and froth flotation agents, known as frother (e.g. methyl iso-butyl carbinol and pine oil) and collector (e.g. diesel fuel or other hydrocarbon oil, and Nasmin AP7 from Nasaco International Co., Petite Rue 3, 1304 Cossonay, Switzerland), are added using controlled dose rates. Micro particle separators (e.g. Flotation test machines manufactured by Eriez Manufacturing Co., 2200 Asbury Road, Erie, Pa. 16505, USA, by FLSmidth, Vigerslev Allé 77, 2500 Valby, Denmark, by Metso Corporation, Fabianinkatu 9 A, PO Box 1220, FI-00130 Helsinki, Finland, and GTEK Mineral Technologies Co. Ltd.) filled with process water and filtered air from an enclosed air compressor are used to sort hydrophobic carbon materials from hydrophilic mineral materials. Froth containing hydro-carbonaceous particles overflows the tank and this froth is collected in an open, top gutter. The mineral pulp is retained in the separation tank until discharged, whereas the demineralised coal slurry is de-aerated, before being subjected to additional processing.

### Dewatering

The concentrate from froth flotation is dewatered with a filter-press or tube-press to a target range of 20-50% m depending on the actual particle size, under pressure or vacuum, sometimes with air-blowing, to remove water by mechanical means, in order to generate feed for the extruder. Suitable filter-press equipment is manufactured by Metso, FI-00130 Helsinki, Finland, FLSmidth, Valby, Denmark, and by Outotec. Rauhalanpuisto 9, 02230 Espoo, Finland.

In some instances, flocculant (or thickener, e.g. anionic polyacrylamide additive manufactured by Nalco Champion, 1 Ecolab Place, St. Paul, MN 55102-2233, USA) is added to optimise settling properties and underflow density. To optimise the procedure settling tests are carried out to measure settling rates and generate a settling curve, tracking underflow density with time.

Filtration may also be necessary depending on the filtration rate and resultant cake moisture. To optimise the procedure feed % solids (thickened/un-thickened), feed viscosity, pH and filtration pressure will be measured, Filter cloths are chosen after assessment of cake discharge and blinding performance. Suitable filter cloths are manufactured by Clear Edge Filtration, 11607 E 43rd Street North, Tulsa, Oklahoma 74116 USA.

In some circumstances a Decanter Centrifuge can be incorporated into the process design to concentrate the solids content prior to the filter press. Suitable equipment is manufactured by Alfa Laval Corporate AB, Rudeboksvägen 1, SE-226 55 Lund, Sweden.

The product at this stage is referred to as PCP wet cake and typically contains 50-60% m moisture. At moisture levels of approximately 50% m this material is agglomerated and feels dry to the touch.

### Drying

The PCP product may be dried thermally to reduce water content to below 10% m. This may be achieved directly on the PCP, or by pelleting it first to facilitate handling, by conveying it to a belt dryer where oxygen-deprived hot process air is blown directly over the microfine coal. Suitable equipment is manufactured by STELA Laxhuber GmbH, Öttingerstr. 2, D-84323 Massing, Germany or by GEA Group Aktiengesellschaft, Peter-Müller-Str. 12, 40468 Düsseldorf, Germany.

According to further specific embodiments of the invention, at least about 90% by volume (% v) of the PCP particles are no greater than about 25 μm in diameter; optionally no greater than about 15 μm in diameter, optionally no greater than about 5 μm in diameter. Suitably, the PCP has an ash content of less than about 2% m, suitably less than about 1.5% m; optionally not more than 1% m. Optionally, the PCP has sulfur content of less than around 2% m; optionally no greater than around 1%, optionally no greater than 0.5%.

### Agglomeration

According to embodiments of the present invention, there is provided a process that blends either as a dry or wet mix (e.g. as a wet cake, or partially wet cake) the solid particulate matter of PCP with or without an organic or inorganic binder substance in order to agglomerate microfine particles prior to the thermal process steps necessary for preoxidation, devolatilization and/or physical or chemical activation. Wet mix may comprise PCP in the form of a so called “wet cake” obtained directly from the dewatering stage described above in which the water content of the PCP is around 50% m to 60% m. One advantage of the microfine nature of the PCP particles enables PCP material to be produced either dry or at various moisture contents. Where higher moisture content is preferred the surface-held water, such as in wet cake, provides the PCP with additional inherent binder characteristics that are usefully exploited when PCP is added as a minority component in combination with other AC feedstocks. At lower moisture contents, a partially dried wet cake may be used which has a water content of at least 10% m of the PCP and at most 40% m of the PCP, suitably around 30% m of the PCP.

Agglomeration of PCP occurs when primary particles are joined loosely together by adhesion (weak physical interactions) to form larger agglomerates. These agglomerates can be broken by mechanical forces. Agglomerates are an assembly of smaller primary particles that can change size and shape due to the conditions of the surrounding medium (such as pressure, temperature, viscosity etc.). Larger agglomerates may break down into smaller agglomerates or, vice versa, smaller agglomerates may again form larger agglomerates. Extrusion, is a process used to create objects of a fixed cross-sectional profile, and is a technique that may be suitably used to agglomerate fine particles by applying compressive force to a material causing it to flow through an orifice or die. An agglomeration of PCP having an average particle size of less than 25 microns results in an AC product having unexpected properties, such as improved activation surface area and also an absence of binder materials that are not inherently capable of activation.

In addition to surface-held water, suitable binder materials may nevertheless be utilized for the agglomeration of PCP particulate compositions in certain circumstances and may be of organic or inorganic origin, or a combination of both. Inorganic binders may comprise lime, calcium hydroxide, slaked lime, alumina, clay, iron oxide, calcium oxide, silica, and silicates. Organic binders may comprise carbohydrates such as refined or unrefined sugars, molasses, and starches; alginates; cellulose, lignocellulose, sawdust and cellulose derivatives; coal tar pitch, petroleum pitch, ethylene cracker bottoms, gilsonite, coal gasification bottoms, epoxy resins; vegetable oils or fatty acids; glycerol and glycerol esters; natural gums (e.g. xanthan gum, shellac); products of biomass pyrolysis; latex; lignosulfonates; polyacrylates and polyacrylamides; polyalkylene glycols; polyester resins; polyurethanes; and styrene polymers. Typically, the use of an inorganic binder will contribute to an increase in the ash content of the agglomerated PCP composition and the AC obtained therefrom following activation. However, another advantage of the present invention is that this increase in ash content may be offset in part by the inherently low ash of the PCP itself. Hence, this may expand the range of potential inorganic binders available for use where there is a particular need to use one for desired physico-chemical characteristics such as pellet strength.

In a specific embodiment of the invention the feedstock comprises a particulate coal, such as a bituminous coal, with an average particle size of greater than 50 microns, suitably greater than 70 microns, optionally at least 75 microns. The bituminous coal feedstock may be mixed with a PCP as a binder component up to 50% m—i.e. a 1:1 mixture by mass. In one embodiment the PCP may contribute a minority component in the mix—i.e. less than 50% m. Without wishing to be bound by theory, the combination of PCP of d90 particle size <20 microns in an agglomerated co-mixed solid-solid blend with coal particles of a larger size may allow for optimal volumetric packing further enhancing the available surface area per unit mass of an AC composition post-activation. In an alternative embodiment, a composition is provided containing up to 50% m of PCP as binder and the balance of a particulate biochar feedstock having an average particle size of >50 microns. In one embodiment the PCP may contribute a minority component in the mix i.e. less than 50% m. Similarly to before, the optimal volumetric packing enables the combination of larger biochar particles and smaller PCP to provide a greater available surface area per unit mass of an AC composition post-activation.

A process for the production of an AC composition, according to an embodiment of the invention may include combining the PCP with a binder to cause agglomeration of the PCP particles, thereby forming agglomerated PCP.

The agglomeration steps, with or without binder, may commence with a PCP that is substantially or partially dry (e.g. with a moisture content of up to 10% m or less) or with PCP that is comprised within a wet cake (e.g. with moisture content <60% m), or with a hybrid mix in between of around 20% m, or 30% m of water. The agglomeration stage may be incorporated into a pelletization process in which the PCP is subjected to pelletization, such as via an extrusion process. The agglomerated composition is then exposed to one or more thermal treatment stages, also called pyrolysis, that may include preoxidation and devolatilization prior to chemical or physical activation. Pyrolysis is the thermal decomposition of materials at elevated temperatures in an inert atmosphere resulting in a change of chemical composition. For carbonaceous materials such as PCP volatile liquid and gaseous compounds are evolved during pyrolysis, typically carried out within the temperature range 400° C. to 900° C., leaving a solid residue which is predominantly carbon. Pre-oxidation is a process of oxidation incurred prior to chemical or physical activation.

In an embodiment of the invention the thermal pretreatments may advantageously be carried out at a lower temperature than expected due to the relatively small particle sizes of the PCP which enable more efficient formation of char.

The AC compositions produced according to embodiments of the invention are characterized by surprisingly high surface area, suitably in excess of 500 m²/g, suitably >700 m²/g, typically >800 m²/g, optionally around 1000 m²/g, and routinely at least as high as >1300 m²/g.

Hence, in specific embodiments, as mentioned above, the PCP may be utilized as an organic binding agent (i.e. as a “binder”) itself, in combination with a PAC or GAC obtained from another carbonaceous source. The PCP binder may be present in a composition comprised of carbonaceous material derived from a native coal (e.g. bituminous coal), or from biomass (e.g. biochar). The PCP binder may be present in an amount of not less than around 1% m, 2% m, 5% m, 10% m, 15% m, 20% m and up to around 25% m. The PCP binder may be present in an amount of not more than about 50% m, 30% m, 25% m, 20% m, 15% m and 10% m. In one specific embodiment the carbonaceous feedstock may be mixed with the PCP up to 25% m—i.e. a 3:1 mixture by mass of carbonaceous feedstock to PCP binder. The high level of activation achievable for PCP makes it highly advantageous compared to organic binders (such as polymers) or inorganic binders (such as clay or silica) neither of which will undergo activation themselves. Hence, when used as a binder in the production of an activated carbon composition. PCP contributes to the overall available activation surface for adsorption in the final AC product.

In specific embodiments of the invention the PCP may be present as an additive, such as an additive feedstock or ‘binder’, specifically in order to increase the BET surface area of a biochar derived activated carbon product. In such embodiments, the PCP is in particulate form, typically at least about 90% by volume (% v) of the particles are no greater than about 25 μm in diameter; and has an ash content of less than about 5% m and a water content of up to about 60% m. As demonstrated in the examples below, the addition of PCP to a biochar derived activated carbon may result in an increase in BET surface are of at least double, optionally more than double, even up to a three-fold increase.

Activated carbon comprised of the compositions and materials described herein may find utility in a range of applications. For instance, activated carbon may be used in remediation of diverse sources of environmentally damaging pollutants, including in wastewater from industrial plants and chemical process facilities which has been improperly disposed of; surface runoff containing fertilisers and pesticides used on agricultural areas; cleaning detergents as well as flame retardants used in fire-fighting foams. Many industrial chemical contaminants are known to persist in nature for decades before degrading, and can cause great harm to plants, animals and humans, even at very low concentrations particularly when present in potable water supplies. Hence, activated carbon compositions as described herein may be used in methods to remove ‘contaminants’ or ‘contaminant substances’ from fluid streams, such as those that comprise water. In the context of the present invention, ‘contaminants’ are intended to encompass substances which may be harmful to the health of humans or animals, or to the environment. Consequently, derivative terms are defined accordingly, for example, a contaminated fluid is a fluid comprising a contaminant substance. In some embodiments, the contaminant comprises an organic compound, optionally a pharmaceutical or pesticide molecule including one or more selected from the group consisting of: diclofenac, erythromycin, estrogens, oxadiazon and thiamethoxam. In certain embodiments the contaminant is a perfluorinated compound, such as a per- and polyfluoroalkyl substances (PFAS). The contaminant may in some embodiments be a metal or metalloid ion, optionally selected from copper, iron, lead, mercury, chromate or arsenate.

The activated carbon compositions described herein are is suitable for contacting a fluid stream that comprises a contaminant substance, such that the substance is adsorbed onto or otherwise taken up from the fluid stream and sequestered by the activated carbon. In specific embodiments, the activated carbon material is deployed within a filter/purifier and/or a bed or a packed column (e.g. including a plurality of stacked filters) and the fluid stream is passed through or across the tilter, bed or packed-column. The activated carbon may be deployed within a mixed bed combined with another adsorbent material such as an ion-exchange resin. In one embodiment the activated carbon is comprised within a prepared component such as a tilter cartridge, so that when used the activated carbon plus adsorbed contaminant can be conveniently contained, and similarly replaced or replenished with fresh activated carbon material as necessary. Alternatively, the activated carbon may be added to the fluid stream as a dispersion. The activated carbon may be particulate, that is to say in the form of granules; flakes; beads; pellets; or pastilles. The activated carbon material may be in the form of a powder which can advantageously provide higher accessible surface area. The activated carbon material may be incorporated into a membrane, or membrane-like tilter. Typically, the activated carbon material when used in compositions for fluid remediation is particulate or granular in form, suitably the average diameter size of the particles or granules (as measured by the largest diameter of the particles) is greater than about 0.01 mm, suitably greater than about 0.1 mm, and typically less than about 5 mm, less than around 3 mm, and optionally less than about 1 mm, or even less than around 500 μm.

The invention is further illustrated by the following non-limiting examples.

### EXAMPLES

### Example 1; Activation of Powdered PCP

The PCP sample used in these investigations was derived from pond tailings waste derived from a US bituminous coal (East Kentucky) mainly originating in Harlan County. PCP as produced had a particle size of d80<5 microns, d98<10 microns, and an ash content of 1% m.

The surface area (SA) and mesopore (1.7-300 nm) characteristics of PCP and other samples were determined by standard nitrogen adsorption using a Tristar 3000 from Micromeritics instrument. SA and pore volume were determined by the BET (Brunauer-Emmett-Teller) method and average pore diameter by the BJH (Barrett, Joyner, and Halenda) method using the desorption isotherm (R. Bardestani, G. S. Patience & S. Kaliaguine, Experimental methods in chemical engineering: specific surface area and pore size distribution measurements—BET, BJH, and DFT, Can. J. Chem. Eng. 2019, Vol 97, pp 2781-2791).

Thus, for unprocessed PCP, a BET SA of 20.6 m²/g and a BJH SA value of similar magnitude (21.6 m²/g) were determined, Table 1 (Test no. 1), together with pore volume (0.091 cm³/g) and average pore size (16.0 nm) values.

### Impact of Pre-Oxidation and Devolatilization

Samples of PCP powder were oxidized in open crucibles inside an oven at a preset temperature of 250° C. for 6 hours and then pyrolyzed at 500° C. for 1 hour to remove volatiles, e.g. Test nos. 3 and 4. Devolatilization alone, Test no. 2, only resulted in reduction of BET SA from 20.6 m²/g to 8.3 m²/g, and reduction in pore volume from 0.091 cm³/g to 0.021 cm³/g. This is expected to occur with swelling bituminous coals because they can enter a plastic phase transition allowing coal material to flow, resulting in collapsed pores.

Oxidation can be used to reduce or eliminate swelling and the flow behavior of bituminous coals. The surprisingly simple combination of pre-oxidation and devolatilization steps increases BET SA by more than a factor of 10 to values in the range 289 m²/g-293 m²/g (tests 3 and 4). Although the pore volume is approximately the same, the average pore size has reduced considerably from 16.0 nm to 9.5 nm. The oxidation step caused a reduction in weight of 40% and the yield from the devolatilization was 84%, giving a net yield of approximately 50%.

TABLE 1
BET SA and BJH pore analysis for samples produced from PCP by different
combinations of devolatilization, pre-oxidation and activation.

| | | | | Surface | Pore | Pore |
|---|---|---|---|---|---|---|
| | Pre-oxidation | Devolatilization | | Area | volume | size |
| Test | 6 hours @ | 1 hour @ | Activation | BET | BET | BJH |
| no. | 250° C. | 500° C. | method | (m²/g) | (cm³/g)†, A | (nm), D |
| 1 | None | None | None | 20.6 | 0.091 | 16.0 |
| 2 | None | Yes | None | 8.3 | 0.021 | 13.4 |
| 3 | Yes (Oven) | Yes | None | 293 | N/A | N/A |
| 4 | Yes (Oven) | Yes | None | 289 | 0.080 | 9.5 |
| 5 | Yes (Autoclave) | Yes | None | 208 | 0.45 | 11.2 |
| 6 | Yes (Oven) | Yes | N₂/KOH | 1266 | 0.29 | 21.3 |
| 7 | Yes (Oven) | Yes | CO₂/KOH | 1369 | 0.25 | 8.7 |

Notes:
BET = Brunauer-Emmett-Teller adsorption method
†Cumulative volume of pores. Adsorption isotherm is typically used for samples where pores are non-uniform and branching.
A = adsorption,
D= Desorption

Pre-oxidation of PCP was also be performed in an autoclave for 6 hours at 250° C. under an air-flow of 0.3 litres per minute, followed by 1 hour at 500° C. devolatilization under nitrogen at the same flow rate. This procedure also led to a 10-fold increase in BET SA from 20.6 m²/g to 208 m²/g (test no. 5). This procedure resulted in highest pore volume achieved, i.e. 0.45 cm³/g.

Thus, the BET SA of PCP powder can be boosted to the range 200 m²/g to 300 m²/g by the above pre-oxidation and devolatilization techniques. This is within the low end of the SA range of commercial activated carbons, though most products range from BET SA 500 to 1500 m²/g. So, the impact of three activation methods was tested to increase BET SA further.

### Impact of Chemical Activation

A sample of oven pre-oxidized, devolatilized PCP was impregnated with aqueous KOH and placed in a custom 316 stainless steel reactor built from tubing and Swagelok parts, being held in the reactor using stainless steel frits with pores of approximately 0.5 microns. The reactor was plumbed into a manifold providing nitrogen for test 6 and CO₂ gas for test 7. Prior to activation, the sample and the reactor were purged with the desired gas, and for activation the reactor was placed inside a preheated oven under a flow of the gas. The outlet of the reactor was fitted with a thermocouple which extends into the oven so that the temperature of the exiting gases from the reactor could be monitored. The flow rate of the gas was controlled using a flow meter. The activation temperature was 850° C. and the flow rate was 0.3 litres per minute.

Under these conditions, powder AC with a high BET SA of 1266 m²/g (final yield 17%) was prepared under nitrogen (test 6). An even higher BET SA of 1368 m²/g (final yield 27%) was obtained using carbon dioxide. These SA values are in the very high range for commercial ACs. The pore volumes were similar for both these AC products (0.29 and 0.25 cm³/g respectively for nitrogen and CO₂ tests respectively). The average pore size obtained from the nitrogen test was much greater (21.3 nm) than that from the CO₂ test (8.7 nm), and even higher than that of the starting PCP itself. In contrast the average pore size from the CO₂ test was the smallest of all the tests.

### Example 2. Activation of Extruded PCP-Containing Pellets

Alternatively, PCP can be agglomerated before activation, which can improve handling of the final AC and also facilities the use of the PCP as a binder component for other carbonaceous substrates such as biochar. This example the focuses on PCP wet cake (>50% water content).

Samples of PCP wet cake and PCP powder were used; the main difference between them was the moisture content, 59% m for wet cake and 2% m for the powder. Analysis of the two samples is provided in Table 2, together with available analytical data for biochar and a low ash US bituminous coal sample (see examples 4 and 5 respectively). Moisture content was determined by ASTM D2867, ash content by ASTM D2866, Volatile matter content by ASTM D5832 or by thermogravimetric analysis (t.g.a.), Ignition Temperature by t.g.a. in air, and BET Surface area and Pore structure using a NOVA surface analyzer.

The bulk density for PCP wet cake was determined as 430 kg/m³ by conventional oven drying yielding an aggregated product which was then ground to a powder. Powdered PCP is manufactured by a ring-drying technique which keeps individual microfine particles discrete and consequently has a much lower bulk density of 250 kg/m³.

Density for the raw pellets was measured by loading pellets into a 1 L graduated cylinder, about 250 mLs at a time, and the cylinder was gently tapped onto a hard surface to allow the pellets to settle and improve packing. The final pellet density after activation was determined by filling a 50 mL cylinder with the entire sample and tapping the cylinder to optimize packing. The mass and volume were then noted.

TABLE 2
Raw material analysis of PCP powder and wet cake

| | | | Volatile | | |
|---|---|---|---|---|---|
| | Moisture | Ash | Matter | Ignition | |
| | Content | Content | Content | Temper- | Bulk |
| | (% m, as | (% m, dry | (% m, dry | ature | Density |
| Material | received) | basis) | basis) | (° C.) | (kg/m³) |
| PCP powder | 2 | 1.2 | 36.2 | 465 | 250 |
| PCP wet cake | 59 | 1.3 | 34.7 | 317 | 430 |
| Biochar | n.a. | 7 | n.a. | n.a. | 610 |
| Low ash | n.a. | 1 | n.a. | n.a. | 850 |
| bituminous | | | | | |
| coal | | | | | |
| PCP-B wet | 18.1 | 2.7 | n.a. | 414 | 490 |
| cake | | | | | |

n.a. not available

### Agglomeration

There are two forms of physical activation: agglomerated and direct. Agglomerated activation combines fine coal particles of the PCP with a binder for uniform activation across and within the particles, whereas unlike Example 1, direct activation typically uses a coarse granular material (>175 microns) as the base raw material.

Different agglomeration formulations were prepared by a standard extrusion method using a Bonnet extruder (https://www.thebonnotco.com/extruders/) with a 4 inch (10.2 cm) auger which produced 4 mm diameter pellets cut to a length of 4-6 mm. These pellets were dried in a 60° C. oven to dry for at least 24 hours:
1. PCP wet cake, as received, was broken down into smaller aliquots and then agglomerated—sample P1;
2. 90% m PCP wet cake was mixed with 10% m inorganic binder (standard bentonite clay with particle size <44 microns)—sample P2;
3. PCP wet cake was broken up into small coin sized pieces, then oven dried at 60° C. to reduce the moisture content to 10% m—sample P3;
4. PCP powder was used as a binder and mixed 1:1 with a feedstock of high volatile bituminous coal with volatile matter content of 35% m (dry basis) and moisture content of 1-5% m—sample P4.

Pellets P1 and P2 were produced with no issues, however, they were very sticky and clumped together due to their high moisture content. Both formulas agglomerated similarly with no apparent difference, despite the inorganic binder in P2. After drying, the pellets were easily separated, however, they were brittle and broke with a light touch. Both P3 and P4 formulae processed well and provided a better initial pellet quality than P1 or P2. The properties of the pellets are shown in Table 3.

TABLE 3
Analysis of agglomerated pellets after drying

| | | | Volatile | | |
|---|---|---|---|---|---|
| | | Ash | Matter | | |
| | | content | content | Ignition | Bulk |
| | Raw Material | (% m, dry | (% m, dry | Temp | Density |
| Pellet | Description | basis) | basis) | (° C.) | (kg/m³) |
| P1 | 60% moisture | 2.7 | 34.3 | 383 | 350 |
| P2 | 60% moisture + | 18.8 | 28.9 | 372 | 400 |
| | 10% clay binder | | | | |
| P3 | 10% moisture | 1.3 | 33.5 | 368 | 550 |
| P4 | 50/50 PCP/ | 2.0 | 36.4 | 363 | 580 |
| | bituminous coal | | | | |
| | blend | | | | |

| D1 | 100% PCP | n.d. | 895 |
|---|---|---|---|
| | hydraulically | | |
| | pressed | | |

All formulae had relatively similar ignition temperatures and volatile matter contents, but there were large differences in ash contents and density. The inorganic binder used in P2 increased the density by 50 kg/m³ compared with P1, however, it also increased the ash content considerably. The much lower moisture content (10% m) in P3 compared with 59% m in P1 contributed to the increase in bulk density to 550 kg/m³ for P3. P4, the blend of PCP with bituminous coal, resulted in the highest bulk density for these agglomerated pellets of 580 kg/m³.

### Heat Treatment—Pyrolysis and Steam Activation

The agglomerated pellets, P1-P4, were first pyrolyzed and then steam activated. During pyrolysis the sample is heated in a furnace under nitrogen gas to drive off volatiles. After activation the pellets have shrunk to 2-3 mm diameter.

For each pyrolysis run, 20 grams of dried sample was first sieved so that all particles were larger than 4 mesh (>4.7 mm). This allowed for a more homogeneous size distribution of the pellets. Once the furnace reached the desired temperature, the pellets were dropped into the one inch diameter (2.54 cm) quartz reactor. After allowing the sample to pyrolyze for 20 minutes, the furnace was turned off and the sample cooled to 150° C. From there it was removed from the furnace, weighed, and analyzed for horizontal compression strength and volatile matter content.

Samples were prepared for a range of different pyrolysis temperatures from 450° C.-750° C., but all were heated for 20 minutes under 3 L/min of nitrogen gas to maintain an inert environment.

The second step of the heat treatment is steam activation in which the char is introduced to steam. The activation furnace parameters were 850° C. for 30 to 90 minutes. For each steam activation, approximately 10 grams of the pyrolyzed char was used. Like pyrolysis, once the furnace reached an internal temperature of 850° C. with an equilibrated steam flow rate of 4 mL/min, the sample was dropped into the reactor and was activated for the designated time. After activation, each sample was cooled under nitrogen flow and then removed from the furnace at a temperature below 150° C.

Following pyrolysis, the mass loss was recorded, and the density and volatile matter content measured for the pyrolyzed pellets. A low volatile matter content indicates that a sample has been thoroughly carbonized. After activation, again mass loss was recorded, together with the shrinkage diameter (as a percentage) and the overall yield. Table 4 shows these results for the pyrolysis and activation of PCP Samples P1-P4 under various conditions as well as the the main activated carbon properties (BET surface area, total pore volume, average pore size, ash content and volatile matter content) for the products from the same set of pyrolysis and activation conditions.

### Temperature Effects (Tests 1-4)

The impact of temperatures was studied for P1 (highest moisture feed) between 450° C. and 750° C., tests 1-4 in Table 4 to determine the ideal temperature conditions for comparison tests. Granular activated carbon with surprisingly high surface areas and unusually low ash contents were produced and an optimum temperature of 550° C. identified.

BET Surface Area: Values between 677 m³/g and 1103 m³/g were obtained, with the higher values at the two lower temperatures (450° C. and 550° C.). These values are commensurate with those of commercial grades Calgon 400 and Calgon 600.

Pore size and volume: In parallel with higher surface area at lower temperatures, higher pore volumes of 0.62 cm³/g and 0.60 cm³/g and higher average pore size (22.5 Å) were obtained at the two lower temperatures (450° C. and 550° C.). These pore volumes and pore sizes are commensurate with those in the two Calgon commercial grades, Table 4.

Yield: Mass loss during pyrolysis, increased with increasing temperature from 22% m (450° C.) to 33% m (750° C.), however this trend reversed during activation when mass loss decreased with increasing temperature from 62% m (450° C.) to 42% m (750° C.). As a result, overall yields of activated carbon were more similar, though actual yield increased with increasing temperature from 30% m (450° C.) to 42% m (750° C.), which are high yields for a coal-based pyrolysis/steam activation carbon process, see ˜20% m yield for Calgon F400, Table 4.

Ash content: Ash content decreased with higher temperatures from 5.1% m to 4.2% m consistent with the increasing yield with increasing temperature. These ash contents are much lower than typical commercial grades with 8-9% m ash. PCP has been prepared from waste coals with ash content as low as 0.3% m (dry basis). Hence, activated carbon could be produced in this way with ash contents as low as 1.0% or even less.

Volatile matter content: During pyrolysis, increased temperature resulted in a lower volatile matter content, in fact Test 1 at 450° C. was not fully pyrolyzed, as volatilization was still occurring at the end of the 20 minutes. These differences were eliminated during activation, as the volatile matter contents of tests 1-4 were all very similar 2.0 m-2.6% m (dry basis).

### Pellet Type and Moisture Content Effects

P1 (Tests 1-6), which contained 60% moisture, surprisingly not only could be pelletised, but also resulted in very high surface areas of >1000 m³/g in three of the tests (Nos. 1, 2 and 6). Ash contents were very low for activated carbons in the range 4.2% m to 7.1% m. Here, surface-held water present in P1 (PCP wet cake) contributes to the binding capacity of the PCP due to capillary forces (Sastry, K. V. S, Pelletization of fine coals, DOE Grant No. DE-FG-22-89PC89766, Univ. of California, 1995, https://www.osti.gov/servlets/purl/171245),

P2 (Test 7), which contained inorganic binder, gave the lowest surface area activated carbon (just 537 m³/g), but also had an unacceptably high ash content of almost 37% m. No further tests were made with this formulation.

P3 (Tests 8-10), which contained PCP wet cake at 10% moisture, resulted in activated carbon with the highest surface area obtained (1349 m³/g in Test 9) and the highest average pore size (27.9 Å) and pore volume (0.94 cm³/g). High BET surface area results from high total pore volume, larger pore size, and greater BJH pore volume. Samples 8 & 9 were heat treated at a starting moisture content of about 20%. Sample 10 was dried to about 1% moisture prior to pyrolysis. It was observed that drying the sample before heat treatments resulted in pellets with increased yield, density (0.44 g/cm³ for Test 10), and hardness after activation, and less diameter shrinkage. Ash contents were very low for activated carbon within the range 3.0% m to 5.9% m.

For a typical seam coal from which this PCP is derived, approximately 3% m of the moisture is pore-held inherent moisture, based on data for Harlan County coals taken from Ruppert, L. F. et al., Chapter G, A Digital Resource Model of the Middle Pennsylvanian Pond Creek Coal Zone, Central Appalachian Basin Coal Region, U.S. Geological Survey Paper 1625-C, 2000, (https://pubs.usgs.gov/pp/p1625c/CHAPTER_G/CHAPTER_G.pdf). For this rank of vitrinite-rich coal, the macroporosity destroyed during milling is estimated at 1% m from data in J. F. Unsworth, C. S. Fowler & L. F. Jones, Moisture in Coal. 2, Maceral effects on pore structure, Fuel, 68, 18 (1989). The remaining 8% will be surface-held water whose resultant capillary forces will contribute to the binding propensity of PCP. Some PCP particles will also be binding themselves together via particle-particle interlocking from electrostatic or van der Waals forces. This binder propensity is derived from the microfine particle size distribution of PCP which leads to an immense number of particle-particle interlocking.

P4 (Tests 11-18), which contained 50% PCP wet cake @ 60% moisture, plus 50% dry bituminous coal, resulted in five of the tests (nos. 13, 14, 15, 17 and 18) with high surface areas >1000 m²/g. In tests 11-15 samples were pyrolyzed with an initial moisture content of approximately 15%, whereas tests 16-18 were dried to a moisture of about 1% before heat treatment. This difference in the pre-drying results in higher density (0.51 g/cm³ for Test 16). Comparison of all the tests shows that pre-dried tests give activated carbon with densities in the range 0.42 g/cm³ to 0.51 g/cm³ (Tests 10-18), whereas the densities of those without pre-drying (Tests 1-9) ranged from 0.26 g/cm³ to 0.39 g/cm³. Despite the presence of higher ash-containing bituminous coal, ash contents were very low for activated carbons in the range 4.6% m to 6.6% m.

Not only does PCP enable the production of binderless pellets suitable for activation, but PCP also acts as a binder for coarser sized bituminous coal particles. Again, this binder propensity is derived from the microfine particle size distribution of PCP which leads to particle-particle interlocking between PCP and bituminous coal as well as PCP to PCP.

P5 (Tests 20-22) contained PCP-B wetcake which had been prepared from the same waste coal source as PCP but with one less ash removal stage. PCP-B wetcake had the following properties:
higher ash content (2.7% m) than PCP-wetcake (1.3% m),
lower moisture content (18.1% m) than PCP wetcake (59% m),
coarser particle size distribution (d80=9.5 μm) than PCP-wetcake (d80=5 μm).

Lower surface areas (512-611 m²/g) and higher activated carbon yields (45-41%) respectively were observed for P5 samples. Test 22 gave the highest surface area (611 m²/) after 120 min of activation time. Although these surface areas are lower than obtained for PCP, many commercial activated carbons are manufactured to this specification, e.g. Norit Darco™, thereby allowing for a trade-off between the degree of processing required for PCP production and the required properties of the AC end product.

TABLE 4
Results of Pyrolysis and Activation

| | | | | | | | | | Activated carbon properties | | | | | |
|---|---|---|---|---|---|---|---|---|---|---|---|---|---|---|
| | | Pyrolysis | | | Activation @ 850° C. | | | | | | Average | | | |
| | | | Mass | Volatile | | Activating | Mass | Overall | Surface | Total pore | pore | | Ash | Volatile |
| Test | Sample | Temp. | Loss | Matter | Time | moisture | Loss | Yield | area | volume | size | Density | Content | Matter |
| No. | ID | 0° C. | % m, db | % m, db | min | % m | % m | % m | m²/g | cm³/g | Å | g/cm³ | % m, db | % m, db |
| 1 | P1 | 450 | 22 | 18 | 60 | 0 | 62 | 30 | 1103 | 0.62 | 22.5 | 0.26 | 5.1 | 2.0 |
| 2 | | 550 | 28 | 9 | 60 | 0 | 54 | 33 | 1065 | 0.60 | 22.5 | 0.33 | 4.6 | 2.2 |
| 3 | | 650 | 31 | 8 | 60 | 0 | 41 | 41 | 677 | 0.32 | 18.9 | 0.37 | 4.2 | 2.6 |
| 4 | | 750 | 33 | 3 | 60 | 0 | 37 | 42 | 795 | 0.39 | 19.9 | 0.34 | 4.2 | 2.2 |
| 5 | | 550 | 27 | 11 | 30 | 0 | 34 | 48 | 686 | 0.32 | 18.6 | 0.39 | 6.5 | 3.4 |
| 6 | | 550 | 27 | 10 | 90 | 0 | 54 | 34 | 1080 | 0.60 | 22.3 | 0.32 | 7.1 | 2.4 |
| 7 | P2 | 550 | 24 | 8.6 | 60 | 0 | 37 | 48 | 537 | 0.26 | 19.5 | 0.32 | 36.6 | 3.4 |
| 8 | P3 | 550 | 26 | 13 | 60 | 20 | 54 | 34 | 789 | 0.38 | 19.2 | 0.33 | 3.6 | 2.7 |
| 9 | | 550 | 27 | 11 | 90 | 20 | 72 | 20 | 1349 | 0.94 | 27.9 | 0.28 | 5.9 | 2.6 |
| 10 | | 550 | 26 | 10 | 60 | 0 | 48 | 39 | 851 | 0.43 | 20.2 | 0.44 | 3.0 | 2.2 |
| 11 | P4 | 550 | 25 | 10.3 | 60 | 15 | 49 | 38 | 895 | 0.44 | 19.6 | 0.42 | 5.1 | 2.0 |
| 12 | | 550 | 25 | 10.0 | 60 | 15 | 41 | 44 | 822 | 0.38 | 18.5 | 0.45 | 4.6 | 2.6 |
| 13 | | 550 | 24 | 10.9 | 90 | 15 | 61 | 30 | 1028 | 0.54 | 20.9 | 0.44 | 6.6 | 2.5 |
| 14 | | 550 | n.d. | n.d. | 90 | 15 | 60 | n.d. | 1149 | 0.62 | 21.6 | 0.42 | n.d. | 2.2 |
| 15 | | 550 | 24 | n.d. | 90 | 15 | 60 | 30 | 1053 | 0.54 | 20.4 | 0.44 | n.d. | n.d. |
| 16 | | 550 | 27 | 11.8 | 60 | 2.4 | 46 | 39 | 813 | 0.37 | 18.1 | 0.51 | 4.7 | 1.7 |
| 17 | | 550 | 27 | 10.4 | 90 | 1.9 | 60 | 29 | 1004 | 0.50 | 19.9 | 0.43 | n.d. | 1.8 |
| 18 | | 550 | 27 | 11.1 | 90 | 0.6 | 58 | 31 | 1026 | 0.51 | 20.0 | 0.43 | n.d. | 1.8 |
| 19 | D1- | 550 | 26 | n.d. | 60 | 0 | 50 | 37 | 930 | 0.46 | 19.9 | 0.43 | n.d. | 2.4 |
| | HT-1 | | | | | | | | | | | | | |
| 20 | P5 | 550 | n.d. | n.d. | 60 | 18.1 | n.d. | 44 | 512 | 0.23 | 18.3 | n.d. | 6 | n.d. |
| 21 | | 550 | n.d. | n.d. | 90 | 18.1 | n.d. | 45 | 552 | 0.25 | 18.0 | n.d. | 6 | n.d. |
| 22 | | 550 | n.d. | n.d. | 120 | 18.1 | n.d. | 41 | 611 | 0.29 | 18.7 | n.d. | 6 | n.d. |

| Calgon F400 | ~20 | 954 | 0.59 | 25.1 | 0.44 | 9.0 | |
|---|---|---|---|---|---|---|---|
| Calgon F600 | | 857 | 0.43 | | 0.63 | 8.0 | 1.5 |

It is evident from Table 4 that P2, which is the only sample to contain an inorganic binder, results in the lowest surface area of all samples tested following activation.

### Activation Time

FIG. 2 illustrates how the BET Surface Area increases with increasing activation time for activated carbons prepared from four types of PCP samples:
P1 (test 5 @ 30 min., test 2 @ 60 min. and test 6 @ 90 min.),
P3 (test 8 @ 60 min. and test 9 @ 90 min.),
P4 wet (average of duplicate tests 11 and 12 @ 60 min., and average of triplicate tests 13, 14 and 15 @ 90 min.)
P4 dry (test 16 @ 60 min., and average of tests 17 and 18 @ 90 min.).

Pore volumes show a similar trend to Surface Area with longer activation times leading to higher values in most cases, e.g.
P1: 0.32 cm³/g @ 30 min. to 0.60 cm³/g @ 60 min. and 0.60 cm³/g @ 90 min.
P3: 0.38 cm³/g @ 60 min. and 0.92 cm³/g @ 90 min.,
P4 wet: 0.41 cm³/g @ 60 min., and 0.57 cm³/g @ 90 min.,
P4 dry 0.37 cm³/g @ 60 min., and 0.51 cm³/g @ 90 min.

There is a similar trend of increasing average pore size with increasing activation time.

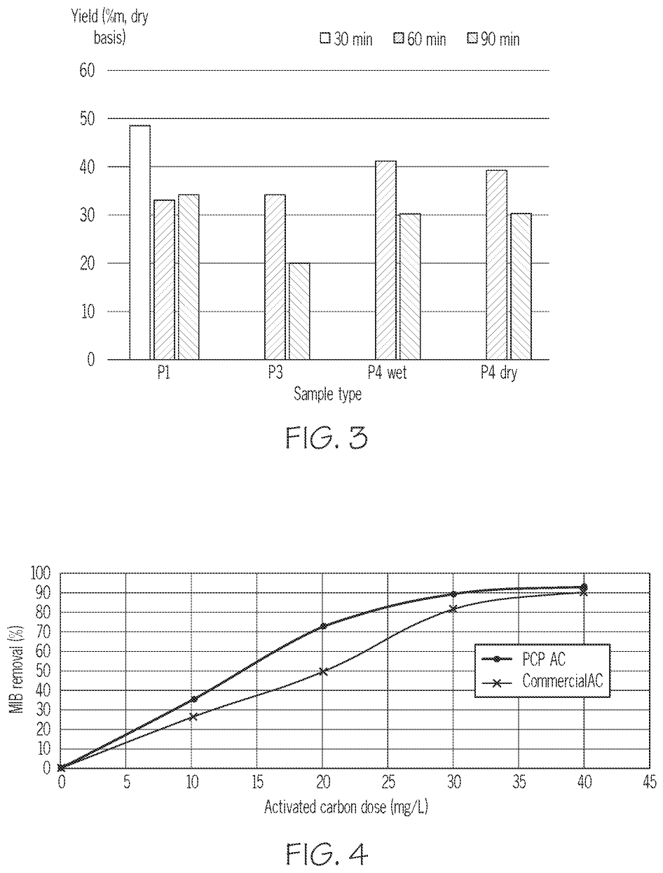

FIG. 3 illustrates how the yield decreases increases with increasing activation time for activated carbons prepared from the same four types of PCP samples. This is to be expected since longer contact time leads to greater mass loss. There is one small exception, P1, where the yield after 90 min. was found to be marginally more than that at 60 min.

Consequently, there is a trade-off for increasing activation time between lower yield versus higher Surface Area, higher pore volume and higher average pore size.

### Example 3. Activation of Hydraulically Compressed PCP Discs

Another material (D1) was prepared by hydraulically pressing dry, PCP powder into three small cylindrical discs of approximately 25 mm in diameter and 8 mm in height. An average bulk density of 895 kg/m³ was determined, Table 3, for these discs from their individual calculated volumes and the measured masses, which was higher than any of extruded pellets P1 to P4.

The discs were broken up into smaller fragments for pyrolysis and activation and these results are given in Table 4. The resultant activated carbon had a high Surface Area of 930 m²/g, with a pore volume of 0.46 cm³/g, an average pore size of 19.9 Å (Angstroms) and a density of 0.43 g/cm³, i.e. similar characteristics to those activated carbons prepared with from pellet containing moisture as a binder.

In D1, dry PCP particles are effectively binding themselves together via particle-particle interlocking from electrostatic or van der Waals forces (Sastry, K. V. S., 1995). This binder propensity is a function of the microfine particle size distribution of PCP.

### Example 4. Activation of Extruded Pellets Prepared from Blends of PCP with Biochar

Biochar lumps derived from lumber mill debris, especially sawdust were ground to a powder with a vertical air-swept hammer mill (a Raymond mill). The resultant biochar powder had a BET surface area of 356 m²/g, see Table 2 (above) also for other properties. Biochar powder was blended with PCP at 3 different proportions: A, B and C as shown in Table 5, below. 50 g dried samples of Blends A, B and C were pyrolyzed at 550° C. for 30 min with a nitrogen flow rate of 3 L/min and subsequently steam activated at 850° C. for 120 min with a steam flow rate of 4 mL/min. Each blend was tested in duplicate and the calculated, average results are given in Table 5.

TABLE 5
Properties of activated carbon derived
from blends of PCP and biochar

| | | | | | Total | |
|---|---|---|---|---|---|---|
| | | | Overall | Surface | pore | Average |
| | PCP | Biochar | Yield | area | volume | pore size |
| Blend | % m | % m | % m | m²/g | cm³/g | A |
| A | 25 | 75 | 42.5 | 982 | 0.72 | 29.1 |
| B | 50 | 50 | 38 | 953 | 0.68 | 28.5 |
| C | 75 | 25 | 37 | 916 | 0.64 | 28.0 |

These surprising results show that addition of PCP to biochar can increase the BET surface area of the resultant activated carbon considerably from 356 m²/g to values in the range of 916 to 982 m²/g. Biochar contains predominantly mesopores, whereas char from PCP is mainly microporosity. Table 4 shows average pore size values mainly in the 18-22 Å range and total pore volumes in the 0.3-0.6 cm³/g range for activated carbons prepared from PCP. Thus both average pore size and total pore volume are increased by addition of biochar to PCP to 28-29 and respectively, This enables activated carbon pore structure to be tailored to give best performance in individual applications.

### Example 5. Activation of Extruded Pellets Prepared from Blends of PCP with Low Ash Bituminous Coal

Low ash bituminous coal, whose properties are given in Table 2, was blended with PCP at 3 different proportions: D, E and F as shown in Table 6, below. 50 g dried samples of Blends D, E and F were pyrolyzed and activated under the same conditions as Example 4 and tested in duplicate with the average results given in Table 5.

TABLE 6
Properties of activated carbon derived
from blends of PCP and biochar

| | | | | | Total | |
|---|---|---|---|---|---|---|
| | | Bituminous | Overall | Surface | pore | Average |
| | PCP | coal B | Yield | area | volume | pore size |
| Blend | % m | % m | % m | m²/g | cm³/g | Å |
| D | 25 | 75 | 31.5 | 977 | 0.52 | 22.0 |
| E | 50 | 50 | 38 | 845 | 0.46 | 22.2 |
| F | 75 | 25 | 35 | 931 | 0.50 | 21.7 |

These results show that PCP can be blended with low ash bituminous coal at different proportions leading to activated carbon with BET surface area in the range of 845 to 977 m²/g. As noted before in example 3, higher yield is associated with slightly lower surface areas, but these results also show that for this blend higher yield is also associated with lower pore volume and higher average pore size.

### Example 6. Performance of PCP-Derived Activated Carbon in Water Treatment Applications

The propensity for PCP-derived activated carbon to remove 2-methylisoborneol (MIB) from drinking water is a standard measurement used to assess efficacy of activated carbons for use in drinking water applications, such as the removal of taste, colour and odour forming compounds, and other trace contaminant substances. (AWWA B600-2016 Standard For Powdered Activated Carbon which describes powdered activated carbon (PAC) for use in adsorption of impurities for water supply service applications). The method includes applying various concentrations of activated carbon in a stirred-jar apparatus. A synthetic water was prepared (US EPA method 600/4-90/027F). The moderately hard synthetic freshwater used contained 1 mg/L of sodium humate to simulate organic carbon competition as commonly found in real world applications. The waters contained 50 ng/L of MIB in the influent water. FIG. 4 shows the % MIB removal efficiency for increasing activated carbon dose, both for PCP-derived activated carbon and a commercially available activated carbon. It is clear that PCP-derived activated carbon removes a higher proportion of MIB for all dose levels. For example, 70% MIB removal requires a PCP dose of 20 mg/L whereas the commercially available option requires a significantly higher dose of 26 mg/L to achieve the same level of MIB removal. So PCP-derived activated carbon is a very efficient method for improving water quality.

### Overall Conclusions

1) The microfine particle size of PCP and PCP wet cake enables the preparation of cohesive pellets ranging in density from 350 g/cm³ to 895 g/cm³ which are suitable for subsequent pyrolysis and activation to manufacture activated carbon. Not only does PCP enable the production of binderless, agglomerated pellets suitable for activation, but PCP also acts as a binder for coarser sized bituminous coal particles. This agglomeration propensity is derived from the microfine particle size distribution of PCP.
2) Surface-held water present in PCP wet cake and partially dried PCP wet cake is acting as a binder to agglomerate the PCP particles due to capillary forces. In the absence of water, dry PCP particles agglomerate together via particle-particle interlocking from electrostatic or van der Waals forces.
3) Pre-oxidation followed by potassium hydroxide chemical activation of PCP as powder resulted in activated carbon with very high surface area of up to 1369 m²/g.
4) Pyrolysis and steam activation treatment of PCP-derived extruded pellets or hydraulically pressed discs resulted in very high surface areas of up to 1349 m²/g and having ash contents as low as 3%.
5) Hence the methods of the invention provide the means to produce high surface area activated carbon with the following novel properties:
Ash contents of below 3% in Example 2, but potentially below 1% m from PCP preparations purified to 0.3% m ash content.
Activated Carbon in which the primary particles are so small that activation is achieved through to the centre of the particle. This is in contrast to microfine activated carbon produced by milling much larger activated particles which inevitably exposes unactivated surfaces where the activation reagent has not penetrated.
6) Because of the absence of an inorganic or organic binder, PCP binderless, agglomerated pellets and moisture-bound pellets benefit from a higher yield (dry basis) of activated carbon with a higher surface area. To manufacture activated carbon, additives are invariably used to bind the carbonaceous powder into an agglomerated form and typically added in quantities ranging from a few percent to 30% m or even 50% m (See for example U.S. Pat. Nos. 5,332,426A, 3,544,507A, 3,901,823A, CN102674341A, CN103011158A, CN103787329B, CN103060053A and U.S. Pat. No. 5,389,325A). Inorganic binders do not affect yield as they remain within the activated carbon structure, but the ash derived from inorganic binder is unactivated reducing product surface area proportionately. Organic binders are lost during the processing as volatile matter, consequently reducing the yield. Avoiding the use of binders maximizes the potential activated carbon yield and surface area. Analogous to the effect of inorganic binder, the low ash content of PCP minimizes the percentage of inert material and further contributes to improving activated carbon yield and surface area.

Although particular embodiments of the invention have been disclosed herein in detail, this has been done by way of example and for the purposes of illustration only. The aforementioned embodiments are not intended to be limiting with respect to the scope of the invention. It is contemplated by the inventors that various substitutions, alterations, and modifications may be made to the invention without departing from the spirit and scope of the invention.

What is claimed is:

1. A process for the production of an activated carbon (AC), the process comprising the steps of:
(i) providing an agglomerated purified carbonaceous product (PCP), wherein the PCP is in particulate form, at least about 90% by volume (% v) of the particles are no greater than about 25 μm in diameter; wherein the PCP has an ash content of less than about 5% m and a water content of up to about 60% m;
(ii) subjecting the agglomerated PCP to at least one thermal treatment thereby forming thermally treated agglomerated PCP; and
(iii) subjecting the thermally treated agglomerated PCP to at least one activation process in order to produce the AC.

2. The process of claim 1, wherein at least about 95% v of the PCP particles are no greater than about 25 μm in diameter.

3. The process of claim 1, wherein the average particle size of the PCP is no more than 10 μm.

4. The process of claim 1, wherein the PCP has an ash content of less than about 3% m, typically less than about 2% m, suitably less than 1% m.

5. The process of claim 1, wherein the PCP has water content of up to about 50% m, typically up to 30% m, suitably up to 20% m, and optionally up to 10% m.

6. The process of claim 1, wherein the at least one thermal treatment comprises a preoxidation and/or pyrolysis stage.

7. The process of claim 1, wherein the at least one thermal treatment comprises a devolatilization stage.

8. The process of claim 1, wherein the at least one thermal treatment is carried out at a temperature of not more than about 500° C.

9. The process of claim 8, wherein the at least one thermal treatment is carried out at a temperature of not more than about 450° C.

10. The process of claim 1, wherein the activation process comprises an activation selected from the group consisting of: a physical activation and a chemical activation.

11. The process of claim 1, wherein the PCP is comprised within a wet cake, wherein the wet cake comprises up to about 60% m of water.

12. The process of claim 1, wherein the PCP is comprised within a partially dried wet cake, wherein the partially dried wet cake comprises up to about 30% m of water.

13. The process of claim 1, wherein the agglomeration of PCP particles comprises further addition of an organic or inorganic binder material.

14. The process of claim 1, wherein the agglomeration of PCP particles occurs in the absence of any additional binder material.

15. The process of claim 1, wherein the PCP is obtained from the froth flotation of waste micro fine coal.

16. An activated carbon prepared according to the process described in claim 1, wherein the composition has a BET surface area of at least 500 m²/g.

17. An activated carbon prepared according to the process described in claim 1, wherein the composition has a BET surface area of at least 800 m²/g, suitably 900 m²/g, and optionally 1000 m²/g.

18. A process for the production of an activated carbon (AC) product, the process comprising the steps of:
(i) providing a carbonaceous feedstock material in particulate form;
(ii) agglomerating the carbonaceous feedstock material with a binder, thereby forming an agglomerated feedstock, wherein the binder comprises a purified carbonaceous product (PCP), wherein the PCP is in particulate form, at least about 90% by volume (% v) of the particles are no greater than about 25 μm in diameter; wherein the PCP has an ash content of less than about 5% m;
(iii) subjecting the agglomerated feedstock to at least one thermal treatment thereby forming thermally treated agglomerated feedstock; and
(iv) subjecting the thermally treated agglomerated feedstock to at least one activation process in order to produce an AC composition.

19. The process of claim 18, wherein the carbonaceous feedstock material is selected from: a native coal; biochar; and charcoal.

20. The process of claim 18, wherein the at least one thermal treatment is carried out at a temperature of not more than 500° C.

21. The process of claim 18, wherein the at least one thermal treatment is carried out at a temperature of not more than 450° C.

22. The process of claim 18, wherein the activation process comprises an activation selected from the group consisting of: a physical activation and a chemical activation.

23. The process of claim 18, wherein the PCP is comprised within a wet cake, wherein the wet cake comprises up to 60% m of water.

24. The process of claim 18, wherein the PCP is comprised within a partially dried wet cake, wherein the partially dried wet cake comprises up to 30% m of water.

25. The process of claim 18, wherein the binder further comprises an inorganic binder material.

26. An activated carbon product prepared according to the process described in claim 18, wherein the composition has a BET surface area of at least 500 m²/g and an ash content of less than about 5% m of ash.

27. The activated carbon product of claim 26, wherein the composition has an ash content of less than about 2% m of ash.

28. A process for the adsorption of a substance comprised within a fluid stream, the process comprising exposing the fluid stream to an activated carbon product prepared according to the process described in claim 1.

29. The process of claim 28, wherein the fluid stream comprises water.

30. The process of claim 29, wherein the substance is selected from one or more of the group consisting of: an organic compound, optionally a pharmaceutical or pesticide molecule; a perfluorinated compound; and a metal or metalloid ion, optionally selected from copper, iron, lead, mercury, chromate or arsenate.

31. The process of claim 28, wherein the activated carbon product is comprised within a filter/purifier, a bed or a packed column.

32. The use of an agglomerated purified carbonaceous product (PCP) as an additive feedstock to increase the BET surface area of a biochar derived activated carbon product, wherein the PCP is in particulate form, at least about 90% by volume (% v) of the particles are no greater than about 25 μm in diameter; wherein the PCP has an ash content of less than about 5% m and a water content of up to about 60% m.

33. The use of claim 32, wherein the PCP is present in an amount of up to about 50% m.

34. The use of claim 32, wherein the PCP increases the BET surface area of a biochar derived activated carbon product by at least double, compared to the BET surface area of a biochar derived activated carbon product alone.

35. A process for the adsorption of a substance comprised within a fluid stream, the process comprising exposing the fluid stream to an activated carbon product prepared according to the process described in claim 18.
